(19) United States
(12) Patent Application Publication
(10) Pub. No.: US 2011/0306728 A1
(43) Pub. Date: Dec. 15, 2011

(54) POLYMER POLYOLS PREPARED FROM NITRILE-FREE AZO-INITIATORS

(75) Inventors: Rick L. Adkins, Dunbar, WV (US); Jiong England, Orange, CA (US); Norbert Hahn, Frechen (DE)

(73) Assignees: Bayer MaterialScience AG, Leverkusen (DE); Bayer MaterialScience LLC, Pittsburgh, PA (US)

(21) Appl. No.: 12/813,746

(22) Filed: Jun. 11, 2010

(51) Int. Cl. C08L 71/02

(52) U.S. Cl. 524/881

(57) ABSTRACT

This invention relates to nitrile-free azo initiators for the preparation of polymer polyols and to the polymer polyols prepared therefrom. These novel polymer polyols comprise a base polyol, a preformed stabilizer and at least one ethylenically unsaturated monomer, in the presence of at least one free-radical polymerization initiator comprising as azo compound that is free of nitrile groups, and optionally, a polymer control agent. The process of preparing these polymer polyols is a continuous process comprising free-radically polymerizing a base polyol, a preformed stabilizer, and at least one ethylenically unsaturated monomer, in the presence of at least one free-radical polymerization initiator comprising as azo compound that is free of nitrile groups, and optionally, a polymer control agent.

### BACKGROUND OF THE INVENTION

This invention relates to polymer polyols prepared from an initiator comprising an azo compound that is free of nitrile groups, and to a process for the preparation of these polymer polyols. The present invention also relates to a process for the preparation of polyurethane foams comprising reacting a polyisocyanate with an isocyanate-reactive component which comprises a polymer polyol as described herein.

Polymer polyols and processes for their preparation are known and described in, for example, U.S. Pat. Nos. 5,196,476, 6,013,731 and 7,179,882. Typically, these are prepared from azo initiators such as 2,2′-azobisisobutyronitrile or peroxide initiators such as tert-amy peroxy pivalate or tert-butyl peroxy diethylacetate.

U.S. Pat. No. 6,642,306 describes the preparation of stable dispersions of polymers in a polyol in which the initiator is an azocarboxylic acid ester or a mixture of azocarboxylic acid esters which correspond to a specific structure.

U.S. Published Patent Application 2007/0254973 describes the preparation of high solids stable graft polyols in which the initiator is an azocarboxylic acid ester of specific structure, i.e. dimethyl-2,2′-bisisobutyrate (V601, Wako Chemicals). Both U.S. Pat. No. 6,642,306 and U.S. Published Patent Application 2007/0254973 deal with the azocarboxylic acid ester initiators in a semibatch (i.e. semicontinuous) polymer polyol (or graft polyol) process.

We have surprisingly found that these azocarboxylic acid esters are not suitable for all semibatch polymer polyol processes. More importantly, we have discovered that these azocarboxylic acid esters in a continuous PMPO process results in a more robust process. In addition, the polyurethane foam made from the resultant polymer polyol products have improved physical properties compared to polyurethane foams made from conventional polymer polyols.

### SUMMARY OF THE INVENTION

This invention relates to polymer polyols that comprise the reaction product of:
(1) a base polyol,
(2) a preformed stabilizer,

and
(3) at least one ethylenically unsaturated monomer,
   in the presence of
(4) at least one free-radical polymerization initiator comprising an azo compound that is free of nitrile groups,
   and, optionally,
(5) a polymer control agent.

These polymer polyols typically have a solids content of from about 20% to about 60% by weight, based on the total weight of the polymer polyol. The free radical polymerization initiator is typically present in an amount of from about 0.01% to about 2% by weight, based on 100% by weight of the total feed. Suitable styrene/acrylonitrile ratios for these polymer polyols range from about 20:80 to about 80:20 (on a weight basis) of styrene to acrylonitrile (S/AN).

The present invention also relates to a process for the preparation of these polymer polyols. This process comprises

(A) free-radically polymerizing:
(1) a base polyol,
(2) a preformed stabilizer,
and
(3) at least one ethylenically unsaturated monomer, in the presence of:
(4) at least one free-radical polymerization initiator that comprises an azo compound which is free of nitrile groups,
and, optionally,
(5) a polymer control agent.

Another aspect of the invention is a process for the preparation of polyurethanes comprising reacting a polyisocyanate component with an isocyanate-reactive component in which at least a portion of the isocyanate-reactive component comprises a polymer polyol as described above.

### DETAILED DESCRIPTION OF THE INVENTION

As used herein, the following terms shall have the following meanings.

The term “monomer” means the simple unpolymerized form of chemical compound having relatively low molecular weight, e.g., acrylonitrile, styrene, methyl methacrylate, and the like.

The phrase “free radically polymerizable ethylenically unsaturated monomer” means a monomer containing ethylenic unsaturation (>C═C<, i.e. two double bonded carbon atoms) that is capable of undergoing free radically induced addition polymerization reactions.

The term pre-formed stabilizer is defined as an intermediate obtained by reacting a macromer containing reactive unsaturation (e.g. acrylate, methacrylate, maleate, etc.) with monomers (i.e. acrylonitrile, styrene, methyl methacrylate, etc.), optionally, in a polymer control agent or PCA, (i.e. methanol, isopropanol, toluene, ethylbenzene, etc.) and/or optionally, in a polyol, to give a co-polymer (dispersion having e.g. a low solids content (e.g. <20%), or soluble grafts, etc.).

The term “stability” means the ability of a material to maintain a stable form such as the ability to stay in solution or in suspension.

The phrase “polymer polyol” refers to such compositions which be produced by polymerizing one or more ethylenically unsaturated monomers dissolved or dispersed in a polyol in the presence of a free radical catalyst to form a stable dispersion of polymer particles in the polyol. These polymer polyols have the valuable property of imparting to, for example, polyurethane foams and elastomers produced therefrom, higher load-bearing properties than are provided by the corresponding unmodified polyols.
As used herein “polymer residue” refers to the solids that remain on a 150-mesh screen after filtering a 33% solution of PMPO in isopropanol. In general, the amount of polymer residue remaining of a 150-mesh screen should be less than 5 ppm. The ppm of polymer residue is calculated using the formula:

$$\frac{{Wt}_{PR}}{{Wt}_{p}} \times {10}^{6}$$

wherein:
Wt_{PR} is the weight in grams of the polymer residue present on screen
and
Wt_{P} is the weight in grams of the undiluted PMPO product.

As used herein “viscosity” is in mPa·s, measured at 25° C. on Anton-Parr Stabinger 3000 viscometer.

Suitable polyols to be used as the base polyols in the present invention include, for example, polyether polyols. Suitable polyether polyols include those having a functionality of at least about 2, preferably at least about 2, and more preferably at least about 3. The functionality of suitable polyether polyols is less than or equal to about 10, preferably less than or equal to about 8, and most preferably less than or equal to about 6. The suitable polyether polyols may also have functionalities ranging between any combination of these upper and lower values, inclusive. The OH numbers of suitable polyether polyols is at least about 10, preferably at least about 15, and most preferably at least about 20. Polyether polyols typically also have OH numbers of less than or equal to about 1900, preferably less than or equal to about 600, more preferably less than or equal to about 400, and most preferably less than or equal to about 100. The suitable polyether polyols may also have OH numbers ranging between any combination of these upper and lower values, inclusive. The (number average) molecular weights of suitable polyether polyols is typically greater than about 200, preferably at least about 2,000 and most preferably at least about 3,000. Polyether polyols typically have (number average) molecular weights of less than or equal to 15,000, more preferably less than or equal to 12,000 and most preferably less than or equal to 8,000. The suitable polyether polyols may also have (number average) molecular weights ranging between any combination of these upper and lower values, inclusive.

As used herein, the hydroxyl number is defined as the number of milligrams of potassium hydroxide required for the complete hydrolysis of the fully phthalylated derivative prepared from 1 gram of polyol. The hydroxyl number can also be defined by the equation:

OH=(56.1×1000×f)/mol. wt.

wherein:
OH: represents the hydroxyl number of the polyol,
f: represents the functionality of the polyol, i.e. the average number of hydroxyl groups per molecule of polyol,
and
mol. wt. represents the molecular weight of the polyol.

Examples of such compounds include polyoxyethylene glycols, triols, tetrols and higher functionality polyols, polyoxypropylene glycols, triols, tetrols and higher functionality polyols, mixtures thereof, etc. When mixtures as used, the ethylene oxide and propylene oxide may be added simultaneously or sequentially to provide internal blocks, terminal blocks or random distribution of the oxyethylene groups and/or oxypropylene groups in the polyether polyol. Suitable starters or initiators for these compounds include, for example, ethylene glycol, propylene glycol, diethylene glycol, dipropylene glycol, tripropylene glycol, trimethyol-propane, glycerol, pentaerythritol, sorbitol, sucrose, ethylenediamine, toluene diamine, etc. By alkoxylation of the starter, a suitable polyether polyol for the base polyol component can be formed. The alkoxylation reaction may be catalyzed using any conventional catalyst including, for example, potassium hydroxide (KOH) or a double metal cyanide (DMC) catalyst.

Other suitable polyols for the base polyol of the present invention include alkylene oxide adducts of non-reducing sugars and sugar derivatives, alkylene oxide adducts of phosphorus and polyphosphorus acids, alkylene oxide adducts of polyphenols, polyols prepared from natural oils such as, for example, castor oil, etc., and alkylene oxide adducts of polyhydroxyalkanes other than those described above.

Illustrative alkylene oxide adducts of polyhydroxyalkanes include, for example, alkylene oxide adducts of 1,3-dihydroxypropane, 1,3-di-hydroxybutane, 1,4-dihydroxybutane, 1,4-, 1,5- and 1,6-dihydroxyhexane, 1,2-, 1,3-, 1,4- 1,6- and 1,8-dihydroxyoctane, 1,10-dihydroxydecane, glycerol, 1,2,4-tirhydroxybutane, 1,2,6-trihydroxyhexane, 1,1,1-trimethyl-olethane, 1,1,1-trimethylolpropane, pentaerythritol, caprolactone, polycaprolactone, xylitol, arabitol, sorbitol, mannitol, and the like.

Other polyols which can be employed include the alkylene oxide adducts of non-reducing sugars, wherein the alkoxides have from 2 to 4 carbon atoms. Non-reducing sugars and sugar derivatives include sucrose, alkyl glycosides such as methyl glycoside, ethyl glucoside, etc. glycol glucosides such as ethylene glycol glycoside, propylene glycol glucoside, glycerol glucoside, 1,2,6-hexanetriol glucoside, etc. as well as alkylene oxide adducts of the alkyl glycosides as disclosed in U.S. Pat. No. 3,073,788, the disclosure of which is herein incorporated by reference. Other suitable polyols include the polyphenols and preferably the alkylene oxide adducts thereof wherein the alkylene oxides have from 2 to 4 carbon atoms. Among the polyphenols which are suitable include, for example bisphenol A, bisphenol F, condensation products of phenol and formaldehyde, the novolac resins, condensation products of various phenolic compounds and acrolein, including the 1,1,3-tris(hydroxy-phenyl)propanes, condensation products of various phenolic compounds and glyoxal, glutaraldehyde, other dialdehydes, including the 1,1,2,2-tetrakis(hydroxyphenol)ethanes, etc.

The alkylene oxide adducts of phosphorus and polyphosphorus acid are also useful polyols, These include ethylene oxide, 1,2-epoxy-propane, the epoxybutanes, 3-chloro-1,2-epoxypropane, etc. as preferred alkylene oxides. Phosphoric acid, phosphorus acid, the polyphosphoric acids such as, tripolyphosphoric acid, the polymetaphosphoric acids, etc. are desirable for use herein.

Polyester polyols are also suitable as the base polyol of the present invention. Suitable polyester polyols for the present invention include, for example, those having a functionality of from about 2 to about 4 hydroxyl (i.e. OH) groups per molecule, having a (number average) molecular weight of from about 300 to about 10,000, and which are characterized by an OH number of from about 20 to about 400. These polyester polyols are the reaction products of (i) one or more aliphatic or aromatic dicarboxylic or polycarboxylic acids, or anhydrides thereof, with (ii) one or more diols, triols or polyols.

The polyester polyols of the present invention typically have an OH number of at least 20, preferably at least 25 and most preferably at least 35. These polyester polyols also typically have an OH number of less than or equal to 400, preferably less than or equal to 300 and more preferably less than or equal to 150. The polyester polyol may have an OH number ranging between any combination of these upper and lower values, inclusive, e.g., from 20 to 40, preferably from 25 to 300, and more preferably from 35 to 150.

These polyester polyols typically have a (number average) molecular weight of at least 300, preferably at least 500 and most preferably at least 600. These polyester polyols also typically have a (number average) molecular weight of less than or equal to 10,000, preferably less than or equal to 8000 and more preferably less than or equal to 6000. The polyester polyol may have a (number average) molecular weight ranging between any combination of these upper and lower values, inclusive, e.g., from 300 to 10,000, preferably from 500 to 8000, and more preferably from 600 to 6000.

Suitable aliphatic dicarboxylic acids for preparing the polyester polyols herein include, for example, saturated or unsaturated C₄ to C₁₂ aliphatic acids, including branched, unbranched, or cyclic materials such as succinic acid, glutaric acid, adipic acid, pimelic acid, suberic acid, maleic acid, fumaric acid, azelaic acid, sebacic acid, 1,11-undecanedioc acid, 1,12-dodecanedioic acid, 1,4-cyclohexanedicarboxylic acid, 2-methylpentanedioic acid, 1,4-cyclo-2-hexenedicarboxylic acid, etc. Suitable aliphatic dicarboxylic acids for preparing the polyester polyols herein include, for example, 1,1,1-propanetricarboxylic acid, ethylenediamine tetraacetic acid, etc. Preferred aliphatic dicarboxylic acids are succinic acid, glutaric acid, adipic acid and mixtures thereof. Suitable aromatic dicarboxylic and/or polycarboxylic acids include, for example, phthalic acid, terephthalic acid, 1,2,4,5-benzenetetracarboxylic acid, etc. Anhydrides which may be used instead include compounds such as, for example, phthalic anhydride, terephthalic anhydride, maleic anhydride, succinic anhydride, etc.

Suitable diols and triols to be reacted with the dicarboxylic and/or polycarboxylic acids in preparing the polyester polyols herein include compounds such as ethylene glycol, propylene glycol, butylene glycol, 1,3-butanediol, neopentyl glycol, diethylene glycol, dipropylene glycol, triethylene glycol, tripropylene glycol, glycerol, trimethylolethane, trimethyolpropane, pentanediol, hexanediol, heptanediol, 1,3- and 1,4-dimethylol cyclohexane and mixtures thereof, etc. Preferred diols and triols for preparing the polyester polyols are diethylene glycol, ethylene glycol, butylene glycol, neopentyl glycol, and mixtures thereof.

It is also possible for the base polyol to comprise one or more conventional polybutadiene polyols, polycaprolactones, polythioether polyols, polycarbonate polyols, polyacetals, etc. It should also be appreciated that blends or mixtures of various useful polyols may be used if desired.

Preformed stabilizers are optional in accordance with the present invention. It is, however, preferred that a preformed stabilizer is present in the polymer polyols and process of preparing these polymer polyols. Suitable preformed stabilizers include, for example, those which are known in the art and include without limitation those described in the references discussed herein. Preferred preformed stabilizers include those discussed in, for example, U.S. Pat. Nos. 4,148,840 (Shah), 5,196,476 (Simroth), 5,364,906 (Critchfield) 5,990,185 (Fogg), 6,013,731 (Holeschovsky et al), 6,455,603 (Fogg), and 7,179,882 (Adkins et al), the disclosures of which are hereby incorporated by reference.

Suitable preformed stabilizers herein include those so-called intermediates obtained by reacting a macromolecule with one or more monomers (i.e. acrylonitrile, styrene, methyl methacrylate, etc.), to give a copolymer (dispersion having a low solids content, e.g. <25% or soluble grafts, etc.). The macromolecule may be obtained by linkage of polyether polyols through coupling with a material such as a polyisocyanate, epoxy resin, etc. or by other means to produce a high molecular weight polyol. The macromolecule preferably contains reactive unsaturation and is, in general, prepared by the reaction of the selected reactive unsaturated compound with a polyol. The terminology “reactive unsaturated compound,” refers to any compound capable of forming an adduct with a polyol, either directly or indirectly, and having carbon-to-carbon double bonds which are adequately reactive with the particular monomer system being utilized. More specifically, compounds containing alpha, beta unsaturation are preferred. Suitable compounds satisfying this criteria include the maleates, fumarates, acrylates, and methacrylates. While not alpha, beta unsaturated compounds, polyol adducts formed from substituted vinyl benzenes, such as chloromethylstyrene, likewise may be utilized. Illustrative examples of suitable alpha, beta unsaturated compounds which may be employed to form the precursor stabilizer include maleic anhydride, fumaric acid, dialkyl fumarates, dialkyl maleates, glycol maleates, glycol fumarates, isocyanatoethyl methacrylate, 1,1-dimethyl-m-isopropenylbenzyl-isocyanate, methyl methacrylate, hydroxyethyl methacrylate, acrylic and methacrylic acid and their anhydride, methacroyl chloride and glycidyl methacrylate. The level of ethylenic unsaturation in the precursor stabilizer may vary widely. The minimum and maximum levels of unsaturation both are constricted by the dispersion stability that the precursor stabilizer is capable of imparting to the polymer polyol composition. The specific level of unsaturation utilized further will depend on the molecular weight and functionality of the polyol used to prepare the precursor stabilizer. Optionally, a diluent, polymer control agent (i.e. molecular weight regulator) may also be present.

Typically, suitable preformed stabilizers for the present invention are derived from:
(a) a macromolecule, macromer or other suitable precursor stabilizer;
(b) a free radically polymerizable ethylenically unsaturated monomer, preferably acrylonitrile and at least one other ethylenically unsaturated comonomer copolymerizable therewith;
(c) a free radical polymerization initiator;
(d) optionally, a polymer control agent in which (a), (b), and (c) are soluble, but in which the resultant preformed stabilizer is essentially insoluble;
   and/or
(e) optionally, one or more polyols.

In general, the amount of the components, on a weight percent of the total formulation, for forming preformed stabilizer is as follows:
(a) 10 to 40, more preferably 15 to 35;
(b) 10 to 30, more preferably 15 to 25;
(c) 0.01 to 2, more preferably 0.1 to 2;
(d) 30 to 80, more preferably 40 to 70;
   and
(e) 0 to 20, more preferably 0 to 10.

In the formulations proposed above for the preformed stabilizer, the %'s by weight of components (a), (b), (c), and optionally (d), and optionally (e), totals 100% by weight of the preformed stabilizer component (2).

Suitable preformed stabilizers for the present invention include those comprising the free radical polymerization product of a free radically polymerizable ethylenically unsaturated monomer, and an adduct of a alcohol having the average formula:

A(OROX)_{≧1}

wherein A is a polyvalent organic moiety, the free valence of which is ≧1, R is the divalent residue comprising an alkylene oxide moiety, and X is one or more of an organic moiety containing reactive unsaturation, copolymerizable with A, and hydrogen, about one of such X is the organic moiety containing reactive unsaturation and the remaining X's are hydrogen, in which the adduct may be further adducted with an organic polyisocyanate.

Suitable compounds to be used as the macromolecule, the macromer or the precursor stabilizer (i.e. component (a) above) include, for example, compounds which contain reactive unsaturation (e.g. acrylate, methacrylate, maleate, fumarate, isopropenylphenyl, vinyl silyl, etc.), obtained by reacting compounds containing reactive unsaturation with alcohols having the average formula A(OROX)_{≧1}. Examples include but are not limited to, maleic anhydride, fumaric acid, dialkyl fumarates, dialkyl maleates, glycol maleates, glycol fumarates, isocyanatoethyl meth-acrylate, methyl methacrylate, hydroxyethyl methacrylate, acrylic and methacrylic acid and their anhydride, methacryl chloride, and glycidyl methacrylate, vinylmethoxysilane, etc.

The reactive unsaturated compound may also be the reaction product of, for example, hydroxymethyl or hydroxyethyl methacrylate with a polyol by coupling through use of an organic polyisocyanate as described in U.S. Pat. No. 4,521,546, the disclosure of which is herein incorporated by reference, or by reaction with an unsaturated mono-isocyanate such as, for example, 1,1-dimethyl-m-isopropenylbenzyl isocyanate, etc. Other suitable precursor stabilizers compounds are obtained by reacting a silicon atom containing compound with a polyether polyol, as described in U.S. Pat. No. 4,883,832 (Cloetens et al), the disclosure of which is herein incorporated by reference.

Suitable compounds to be used component (b) above, include reactive unsaturated compounds, particularly those that are free radically polymerizable. Some examples of suitable compounds include aliphatic conjugated dienes, monovinylidene aromatic monomers, α,β-ethylenically unsaturated carboxylic acids and esters thereof, α,β-ethylenically unsaturated nitriles and amides, vinyl esters, vinyl ethers, vinyl ketones, vinyl and vinylidene halides and a wide variety of other ethylenically unsaturated materials which are copolymerizable with the aforementioned monomeric adduct or reactive monomer. Such monomers are known in polymer polyol chemistry. Mixtures of two or more of such monomers are suitable herein.

Preferred monomers are the monovinylidene aromatic monomers, particularly styrene, and the ethylenically unsaturated nitriles, particularly acrylonitrile. In particular, it is preferred to utilize acrylonitrile with a comonomer and to maintain a minimum of about 5 to 15 percent by weight acrylonitrile in the system. Styrene is generally preferred as the comonomer, but other monomers may be employed. A most preferred monomer mixture comprises acrylonitrile and styrene. The weight proportion of acrylonitrile can range from about 20 to 80 weight percent of the comonomer mixture, more typically from about 25 to about 55 weight percent, and styrene can accordingly vary from about 80 to about 20 weight percent, more preferably from 75 to 45 weight percent of the mixture.

The free radical polymerization initiators suitable for use as component (c) in the suitable preformed stabilizers of the present invention encompass any free radical catalyst suitable for grafting of an ethylenically unsaturated polymer to a polyol. Examples of suitable free-radical polymerization initiators for the present invention include initiators such as, for example, peroxides including both alkyl and aryl hydro-peroxides, persulfates, perborates, percarbonates, azo compounds, etc. The azo compounds which are suitable initiators for the pre-formed stabilizers include both the conventional azo compounds such as azobis(isobutyronitrile), 2,2′-azo bis-(2-methylbutyronitrile), etc., and azo compounds which are free of nitrile groups. The present specification further describes azo compounds which are free of nitrile groups as suitable free-radical polymerization initiators for catalyzing the polymer polyol reaction herein. Such catalysts are known in polymer polyol chemistry. Also useful are catalysts having a satisfactory half-life within the temperature ranges used to form the preformed stabilizer, i.e. the half-life should be about 25 percent or less of the residence time in the reactor at a given temperature.

Suitable catalysts concentrations range from about 0.01 to about 2% by weight, preferably from about 0.05 to 1% by weight, and most preferably 0.05 to 0.3% by weight, based on the total weight of the components (i.e. 100% by weight of the PFS). The particular catalyst concentration selected will usually be an optimum value considering all factors, including costs.

In accordance with the present invention, a polymer control agent (d) in which components (a), (b), and (c) of the pre-formed stabilizer are soluble, but in which the resultant preformed stabilizer component is essentially insoluble, is optional. When present, this may be one polymer control agent or a mixture of polymer control agents. Suitable compounds to be used as polymer control agents in accordance with the present invention include various mono-ols (i.e. monohydroxy alcohols), aromatic hydrocarbons, ethers, and other liquids. Mono-ols are preferred because of their ease of stripping from the composition. The choice of mono-ol is not narrowly critical, but it should not form two phases at reaction conditions and it should be readily stripped from the final polymer/polyol.

The polyol components suitable as component (e) in the present invention include typically the alkylene oxide adduct of A(OH)_{>3} described above. Though the polyol used as component (e) can encompass the variety of polyols described above, including the broader class of polyols described in U.S. Pat. No. 4,242,249, at column 7, line 39 through column 9, line 10, the disclosure of which is herein incorporated by reference, it is preferred that the polyol component (e) be the same as or equivalent to the polyol used in the formation of precursor used in preparing the preformed stabilizer (PFS). Typically, the polyol need not be stripped off.

Because of the number of components, the variability of their concentration in the feed, and the variability of the operating conditions of temperature, pressure, and residence or reaction times, a substantial choice of these is possible while still achieving the benefits of the invention. Therefore, it is prudent to test particular combinations to confirm the most suitable operating mode for producing a particular final polymer polyol product.

The process for producing the preformed stabilizer is similar to the process for making the polymer polyol. The temperature range is not critical and may vary from about 80° C. to about 150° C. or perhaps greater, the preferred range being from 115° C. to 125° C. The catalyst and temperature should be selected so that the catalyst has a reasonable rate of decomposition with respect to the hold-up time in the reactor for a continuous flow reactor or the feed time for a semi-batch reactor.

The mixing conditions employed are those obtained using a back mixed reactor (e.g.—a stirred flask or stirred autoclave). The reactors of this type keep the reaction mixture relatively homogeneous and so prevent localized high monomer to macromer ratios such as occur in tubular reactors, where all of the monomer is added at the beginning of the reactor.

The preformed stabilizer of the present invention comprise dispersions in the diluent and any unreacted monomer in which the preformed stabilizer is probably present as individual molecules or as groups of molecules in “micelles,” or on the surface of small polymer particles.

Suitable compounds to be used as the ethylenically unsaturated monomers, i.e. component (3) the present invention include, for example, those ethylenically unsaturated monomers described above with respect to the preformed stabilizer. Suitable monomers include, for example, aliphatic conjugated dienes such as butadiene and isoprene; monovinylidene aromatic monomers such as styrene, α-methyl-styrene, (t-butyl)styrene, chlorostyrene, cyanostyrene and bromostyrene; α,β-ethylenically unsaturated carboxylic acids and esters thereof such as acrylic acid, methacrylic acid, methyl methacrylate, ethyl acrylate, 2-hydroxyethyl acrylate, 2-hydroxyethyl methacrylate, butyl actylate, itaconic acid, maleic anhydride and the like; α,β-ethylenically unsaturated nitriles and amides such as acrylonitrile, methacrylonitrile, acrylamide, methacrylamide, N,N-dimethyl acrylamide, N-(dimethylamino-methyl)acrylamide and the like; vinyl esters such as vinyl acetate; vinyl ethers, vinyl ketones, vinyl and vinylidene halides as well as a wide variety of other ethylenically unsaturated materials which are copolymerizable with the aforementioned monomeric adduct or reactive monomer. It is understood that mixtures of two or more of the aforementioned monomers are also suitable employed in making the pre-formed stabilizer. Of the above monomers, the monovinylidene aromatic monomers, particularly styrene, and the ethylenically unsaturated nitriles, particularly acrylonitrile are preferred. In accordance with this aspect of the present invention, it is preferred that these ethylenically unsaturated monomers include styrene and its derivatives, acrylonitrile, methyl acrylate, methyl methacrylate, vinylidene chloride, with styrene and acrylonitrile being particularly preferred monomers.

It is preferred that styrene and acrylonitrile are used in sufficient amounts such that the weight ratio of styrene to acrylonitrile (S:AN) is from about 80:20 to 20:80, more preferably from about 75:25 to 25:75. These ratios are suitable for polymer polyols and the processes of preparing them, regardless of whether they comprise the ethylenically unsaturated macromers or the pre-formed stabilizers of the present invention.

Overall, the quantity of ethylenically unsaturated monomer(s) present in the polymer polyols comprising a pre-formed stabilizer is preferably at least about 20% by weight, more preferably at least about 40% by weight, and most preferably at least about 45% by weight, based on 100% by weight of the polymer polyol. The quantity of ethylenically unsaturated monomer(s) present in the polymer polyols is preferably about 65% by weight or less, more preferably at least about 60% by weight or less. The polymer polyols of the present invention typically has a solids content ranging between any combination of these upper and lower values, inclusive, e.g. from 20% to 65% by weight, preferably from 30% to 60% by weight, based on the total weight of the polymer polyol. It is more preferred that the solids content be less than 60% by weight, more particularly preferred that the solids content be less than or equal to about 59% by weight, most preferred that the solids content be less than or equal to about 58% by weight, and most particularly preferred that the solids content be less than or equal to about 55% by weight.

Suitable free-radical initiators to be used as component (4) in the present invention include, for example, any azo compound that is free of nitrile groups. These are also referred to herein as nitrile-free azo initiators. Suitable examples of such azo compounds which are free of nitrile groups include azocarboxylic acid esters which correspond to the fomula (I):

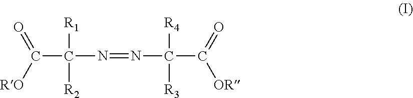

wherein:
R₁, R₂, R₃ and R₄ may be identical or different and each is independently selected from the group consisting of (i) linear or branched alkyls containing from 1 to 9 carbon atoms, preferably 1 to 4 carbon atoms, optionally substituted with one or more substituents selected from hydroxyl, C₁ to C₆ alkoxy and halogen substituents; (ii) C₃ to C₁₂ cycloalkyls, optionally substituted with one or more substituents selected from C₁ to C₆ alkyl, C₁ to C₆ alkoxy, hydroxyl and halo groups; (iii) aralkyls optionally substituted with one or more C₁ to C₆ alkyl, C₁ to C₆ alkoxy, hydroxyl and halo groups; and (iv) aryls optionally substituted with one or more substituents selected from C₁ to C₆ alkoxy, hydroxyl and halo groups; with at least one of the combinations R₁-R₂ and R₃-R₄ possibly forming an aliphatic ring;
and
R′ and R″ may be identical or different and are independently selected from the group consisting of hydrogen, and linear or branched C₁ to C₁₀ and preferably C₁ to C₄ aliphatic radicals.

In accordance with the present invention, it is preferred that R₁, R₂, R₃ and R₄ are each independently selected from a C₁ to C₄ alkyl group that may be linear or branched, and R′ and R″ each independently represent a methyl group or an ethyl group.

Some specific examples of suitable azo compounds that are nitrile free include dimethyl-2,2′-azobisisobutyrate, diethyl-2,2′-azobisisobutyrate, 2-methylethyl-2,2′-azobisisobutyrate, dimethyl-2,2′-azobis(2-methyl-butyrate), diethyl-2,2′-azobis(2-methylbutyrate), 2-methylethyl-2,2′-azobis(2-methylbutyrate). Preferred are dimethyl-2,2′-azobisisobutyrate, diethyl-2,2′-azobisisobutyrate.

One advantage of the azocarboxylic acid esters described herein is their low melting point. Typically, these azocarboxylic acid esters have melting points below 27° C. which means that these are generally liquids at room temperature. As liquids, these are generally easier to disperse in the base polyol than prior initiators such as, for example, azobis(isobutyronitrile), i.e. AIBN.

The preparation of these azocarboxylic acid esters is by a conventional two-step process in which the azonitrile is first converted by reaction with an alcohol in the present of HCl by the Pinner reaction, which forms the corresponding azo imino ether hydrochloride, followed by hydrolysis in the presence of the formed HCl. Other improved processes are known and described in, for example, DE 2254472, EP 80275 and EP 230586, and in U.S. Pat. No. 4,950,742, the disclosure of which is hereby incorporated by reference. Such esters may also be prepared by reacting an azonitrile with an alcohol and hydrochloride in the present of an aromatic solvent, in which the molar ratio of HCl to azonitrile is >2 when methanol is the alcohol and >3 when ethanol and higher alcohols are used.

In accordance with the present invention, the nitrile-free azo initiators are present in amounts of from about 0.05% by weight to about 2.0% by weight, based on 100% by weight of total feed for PMPO process. The amount of nitrile-free azo initiators present in (the total polymer polyol feed) is preferably at least about 0.05% by weight, more preferably at least about 0.10% by weight, and most preferably at least about 0.15% by weight, based on 100% by weight of the total feed. As used herein, the phrase total feed refers to the total amount of all components fed to prepare the polymer polyol. The quantity of the nitrile-free azo initiators present is preferably about 2.0% by weight or less, more preferably about 1.5% by weight or less and most preferably about 1.0% by weight or less. These initiators are typically present in amounts ranging between any combination of these upper and lower values, inclusive, e.g. from 0.05% to 2.0% by weight, preferably from 0.1% to 1.5% by weight, more preferably from 0.15% to 1.0% by weight, and most preferably from 0.2% to 0.8% by weight, based on the total feed. The particular catalyst concentration selected will usually be an optimum value, taking all factors into consideration including costs.

In addition, the polymer polyol and the process of preparing the polymer polyol comprise a polymer control agent, i.e. component (5). The use of polymer control agents and their nature is known in the art. Polymer control agents are also commonly referred to as molecular weight regulators and/or reaction moderators. Typically, polymer control agents serve to control the molecular weight of the polymer polyol.

Suitable polymer control agents and processes for their preparation are known and described in, for example, U.S. Pat. Nos. 3,953,393, 4,119,586, 4,463,107, 5,324,774, 5,814,699 and 6,624,209, the disclosures of which are hereby incorporated by reference. Any of the known polymer control agents may be suitable herein, provided it does not adversely affect the performance of the polymer polyol. Some examples of suitable materials to be used as polymer control agents include compounds methanol, ethanol, n-propanol, isopropanol, n-butanol, sec-butanol, tert-butanol, n-pentanol, 2-pentanol, 3-pentanol, allyl alcohols, toluene, ethylbenzene, mercaptans including, e.g. dodecylmercaptan, octadecylmercaptan, ethane thiol, toluene thiol, etc., halogenated hydrocarbons such as, e.g. methylene chloride, carbon tetrachloride, carbon tetrabromide, chloroform, etc., amines such as diethylamine, triethylamine, enol-ethers, etc. If used in the present invention, a polymer control agent is typically present in an amount of from about 0.1 to about 10 wt. %, more preferably from about 0.2 to about 5 wt. %, based on the total weight of the polymer polyol (prior to stripping).

Preferred polymer control agents are ethanol, isopropanol, tert-butanol, toluene and ethylbenzene.

The polymer polyols are preferably produced by utilizing a low monomer to polyol ratio which is maintained throughout the reaction mixture during the process. This is achieved by employing conditions that provide rapid conversion of monomer to polymer. In practice, a low monomer to polyol ratio is maintained, in the case of a continuous operation, by control of the temperature and mixing conditions.

The temperature range is not critical and may vary from about 80° C. to about 140° C. or perhaps greater, the preferred range being from 115° C. to 125° C. As has been noted herein, the catalyst and temperature should be selected so that the catalyst has a reasonable rate of decomposition with respect to the hold-up time in the reactor for a continuous flow reactor or the feed time for a semi-batch reactor.

The mixing conditions employed are those obtained using a back mixed reactor (e.g.—a stirred flask or stirred autoclave). The reactors of this type keep the reaction mixture relatively homogeneous and so prevent localized high monomer to polyol ratios such as occur in tubular reactors when such reactors are operated with all the monomer added to the beginning of the reactor.

The polymer polyols of the present invention comprise dispersions in which the polymer particles (the same being either individual particles or agglomerates of individual particles) are relatively small in size and, in the preferred embodiment, have a weight average size less than about ten microns. However, when high contents of styrene are used, the particles will tend to be larger; but the resulting polymer polyols are highly useful, particularly where the end use application requires as little scorch as possible.

Following polymerization, volatile constituents, in particular any residues of monomers are generally stripped from the product by the usual method of vacuum distillation, optionally in a thin layer of a falling film evaporator. In the preferred embodiment, all of the product (viz. 100%) will pass through the filter employed in the 150 mesh filtration hindrance (filterability) test that will be described in conjunction with the Examples. This ensures that the polymer polyol products can be successfully processed in all types of the relatively sophisticated machine systems now in use for large volume production of polyurethane products, including those employing impingement-type mixing which necessitate the use of filters that cannot tolerate any significant amount of relatively large particles (i.e. >30 microns).

The following examples further illustrate details for the preparation and use of the compositions of this invention. The invention, which is set forth in the foregoing disclosure, is not to be limited either in spirit or scope by these examples. Those skilled in the art will readily understand that known variations of the conditions and processes of the following preparative procedures can be used to prepare these compositions. Unless otherwise noted, all temperatures are degrees Celsius and all parts and percentages are parts by weight and percentages by weight, respectively.

### EXAMPLES

The following components were used in the examples:
Polyol A: A propylene oxide adduct of glycerin, containing 12% ethylene oxide with a hydroxyl number of 48.
Polyol B: A propylene oxide adduct of sorbitol, containing 8% ethylene oxide with a hydroxyl number of 28.
Polyol C: A propylene oxide adduct of sorbitol, containing 16% ethylene oxide with a hydroxyl number of 28.
Polyol D: A propylene oxide adduct of glycerin, containing 12% ethylene oxide with a hydroxyl number of 52.
Polyol E: A propylene oxide adduct of glycerin, containing 20% ethylene oxide with a hydroxyl number of 36.
Polyol F: A propylene oxide/ethylene oxide adduct of glycerin and sorbitol containing 18% ethylene oxide with a hydroxyl number of 32.
PCA: Isopropanol, a polymer control agent
SAN: Styrene:acrylonitrile
TMI: Isopropenyl dimethyl benzyl isocyanate (an unsaturated aliphatic isocyanate) which is commercially available as TMI® from Cytec Industries
Initiator A: 2,2′-Azobis(2-methylbutyronitrile), a free-radical polymerization initiator commercially available as VAZO 67 from E.I. Du Pont de Nemours and Co.
Initiator B: 2,2′-Azobisisobutyronitrile, a free-radical polymerization initiator commercially available as VAZO 64 from E.I. Du Pont de Nemours and Co.
Initiator C: Dimethyl-2,2′-azobis(isobutyrate), a free-radical polymerization initiator commercially available as V601 from Wako Chemical.
Initiator D: Diethyl-2,2′-azobis(isobutyrate), a free-radical polymerization initiator commercially available as DEAB from Arkema.
Initiator E: tert-Butyl peroxide, a free-radical polymerization initiator, commercially available from Pergan Marshall LLC.
DEOA-LF: Diethanolamine, a commercially available foam crosslinker/foam modifier from Air Products
DC 5043: a silicone surfactant, commercially available from Air Products as DC 5043
33LV: 1,4-Ethylenepiperazine catalyst, commercially available from Air Products as DABCO 33LV
NIAX A-1: Amine catalyst, commercially available from Momentive Performance Materials as NIAX A-1
TDI: Toluene diisocyanate containing about 80% by weight of the 2,4-isomer and about 20% by weight of the 2,6-isomer
Viscosity: Viscosities were measured by an Anton-Parr Stabinger viscometer (mPa·s at 25° C.)
Filtration Filterability was determined by diluting one part by
Hindrance weight sample (e.g. 200 grams) of polymer polyol
(i.e. filterability): with two parts by weight anhydrous isopropanol (e.g. 400 grams) to remove any viscosity-imposed limitations and using a fixed quantity of material relative to a fixed cross-sectional area of screen (e.g. 1⅛ in. diameter), such that all of the polymer polyol and isopropanol solutions passes by gravity through a 150-mesh screen. The 150-mesh screen has a square mesh with average mesh opening of 105 microns and it is a “Standard Tyler” 150 square-mesh screen
Polymer Residue The amount of visible polymer residue left in the 150-mesh screen after air drying residual solvent, measured in ppm. Calculated by (wt residue (g)/wt of undiluted PMPO (g))×10⁶

### General Procedure for Macromer Preparation:

Macromer 1: a glycerine initiated polyether of propylene oxide capped with ethylene oxide containing 13% ethylene oxide, having a hydroxyl number of 19, and an unsaturation content of 0.097 meq/g (see Dispersant 5 of U.S. Pat. No. 4,837,246.
Macromer 2: Prepared by heating Polyol B (100 parts), TMI (2 parts), and 100 ppm stannous octoate catalyst at 75° C. for 2 hours.
Macromer 3: Prepared by heating Polyol C (100 parts), TMI (2 parts), MDI (1.5 parts) and 100 ppm stannous octoate catalyst at 75° C. for 2 hours.

### General Procedure Semibatch PMPO Preparation for Comparison Examples 1-4

The precharge was placed in a 3 L glass reactor under nitrogen and heated to 125° C. The polyol and monomer feeds were pumped into the reactor over 4 hours. The reaction mixture was digested at 125° C. for 1 hour, the residual monomers vacuum stripped, and the product removed from the reactor to give a white liquid polyol with a total solids content of 25%.

TABLE 1
Semibatch PMPO Feeds

Wt % of Total
Feed

Precharge

| | |
|---|---|
| Polyol A | 12.31 |
| Macromer 1 | 3.16 |

Polyol Feed

| | |
|---|---|
| Polyol A | 59.27 |
| Initiator | see Table 2 |

Monomer Feed

| | |
|---|---|
| Styrene | 17.41 |
| Acrylonitrile | 7.46 |

The semibatch feed as set forth in Table 1 was used for each of Comparative Examples 1-4. The initiator for each example, and the respective amount of initiator, is identified in Table 2. As shown in Table 2, Comparative Examples 1-4 illustrate that both Initiator C (i.e. azoester V601) and Initiator D (azoester DEAB) in a semibatch PMPO process result in poor quality product compared to the VAZO 67 control, as determined by the Polymer Residue concentration. Typically, the amount of Polymer Residue present after filtration using a 150 mesh screen should be below 5 ppm.

TABLE 2
Semibatch PMPO Examples

| Comparative | Initiator | Viscosity | Polymer |
|---|---|---|---|
| Examples | (wt %) | (mPa · s) | Residue (ppm) |
| 1 | A (0.39) | 1805 | 3 |
| 2 | C (0.39) | 1765 | 17 |
| 3 | C (0.30) | 1698 | 32 |
| 4 | D (0.35) | 1744 | 21 |

### General Procedure for Preformed Stabilizer (PFS) Preparation:

The pre-formed stabilizers (PFS A and PFS B) were prepared in a two-stage reaction system comprising a continuously-stirred tank reactor (CSTR) fitted with an impeller and 4 baffles (first-stage) and a plug-flow reactor (second stage). The residence time in each reactor was about 60 minutes. The reactants were pumped continuously to the reactor from feed tanks through an in-line static mixer and then through a feed tube into the reactor, which was well mixed. The temperature of the reaction mixture was controlled at 120° C. The product from the second-stage reactor overflowed continuously through a pressure regulator designed to control the pressure in each stage at 65 psig. The product, i.e. the pre-formed stabilizer, then passed through a cooler and into a collection vessel. The preformed stabilizer formulation is disclosed in Table 3.

TABLE 3
Preformed Stabilizer Composition:

| | PFS A | PFS B |
|---|---|---|
| PCA type | Isopropanol | Isopropanol |
| PCA | 30-80% | 30-80% |
| concentration in | | |
| feed, wt-% | | |
| Macromer | Macromer 2 | Macromer 3 |
| Macromer | 10-40% | 10-40% |
| concentration in | | |
| feed, wt-% | | |
| Monomers* | 10-30% | 10-30% |
| concentration in | | |
| feed, wt-% | | |
| Initiator E | 0.1-2% | 0.1-2% |
| concentration, wt- | | |
| % | | |

*SAN = 50/50

In the preformed stabilizer composition described above, the wt. % concentrations are based on the total feed.

### Polymer Polyol Preparation: (Used in Examples 5-11)

This series of examples relates to the preparation of polymer polyols. The polymer polyols were prepared in a two-stage reaction system comprising a continuously-stirred tank reactor (CSTR) fitted with an impeller and 4 baffles (first-stage) and a plug-flow reactor (second stage). The residence time in each reactor was about 60 minutes. The reactants were pumped continuously from feed tanks through an in-line static mixer and then through a feed tube into the reactor, which was well mixed. Table 4 illustrates the basic feed compositions which were used to prepare polymer polyols A1, A2, B1, B2 and B3 as set forth therein. Properties and other characteristics of the Polymer Polyols A1, A2, B1, B2 and B3 are set forth in Examples 5-9 of Table 5. The temperature of the reaction mixture was controlled at 115° C. The product from the second-stage reactor overflowed continuously through a pressure regulator designed to control the pressure in each stage at 45 psig. The product, i.e. the polymer polyol, then passed through a cooler and into a collection vessel. Typical run time for a PMPO was about 19 hours. The crude product was vacuum stripped to remove volatiles. The wt-% total polymer in the product was calculated from the concentrations of monomers measured in the crude polymer polyol before stripping. The preformed stabilizers (PFS A and PFS B) described above were used to produce PMPOs A1, A2, B1, B2 and B3 in Table 4 and Table 5. In Table 5, Examples 5 and 7 are control examples which are representative of the state of the art, and Examples 6, 8 and 9 are representative of the presently claimed invention.

TABLE 4
Polymer Polyol Compositions:

| PMPO | A1 | A2 | B1 | B2 | B3 |
|---|---|---|---|---|---|
| Polyol | D (45.93) | D (45.93) | E (52.11) | E (52.11) | E (52.11) |
| (wt %) | | | | | |
| PFS | A (5.84) | A (5.84) | B (6.92) | B (6.92) | B (6.92) |
| (wt %) | | | | | |
| Initiator | B (0.25) | C (0.25) | B (0.29) | C (0.29) | C (0.20) |
| (wt %) | | | | | |
| Styrene | 31.23 | 31.23 | 25.76 | 25.76 | 25.76 |
| (wt %) | | | | | |
| ACN | 16.75 | 16.75 | 14.92 | 14.92 | 14.92 |
| (wt %) | | | | | |
| % Total | 50 | 50 | 43 | 43 | 43 |
| Solids | | | | | |

TABLE 5
Polymer Polyol Examples

| | | Initiator | Viscosity | Polymer |
|---|---|---|---|---|
| Example | PMPO | (wt %) | (mPa · s) | Residue(ppm) |
| 5 | A1 | B (0.25) | 5623 | 0 |
| 6 | A2 | C (0.25) | 5498 | 0 |
| 7 | B1 | B (0.29) | 5551 | 2 |
| 8 | B2 | C (0.29) | 5396 | 0 |
| 9 | B3 | C (0.20) | 5239 | 2 |

Examples 5-9 illustrate that, contrary to the semibatch examples 1-4, use of Initiator C (i.e. V601) does not lead to poorer quality PMPO as determined by Polymer Residue. Example 6 was as good as control Example 5 in terms of the amount of Polymer Residue, and better than control Example 5 in terms of the viscosity; and Examples 8 and 9 were as good as control Example 7 in terms of the amount of Polymer Residue, and better than control Example 7 in terms of the viscosity.

Furthermore, Examples 10 and 11 in Table 6 clearly illustrate that use of Initiator C actually improves the PMPO process. In Examples 10 and 11, it was attempted to run the same processes as described above in Examples 5 and 6, respectively, in a continuous manner for 67 hours, as opposed to a typical 19 hour run (as shown above in Examples 5 and 6). After 42 hours, the run in Example 10 shut down due to polymer buildup. The run in Example 11 continued for the entire 67 hours without significant polymer buildup. This provides evidence that Initiator C significantly reduced reactor polymer fouling. In addition to Initiator C leading to lower viscosity PMPO, there is a significant advantage due to decreased reactor fouling which permits longer runs.

TABLE 6
Extended Run Results for PMPO A

| | Example 10 | Example 11 |
|---|---|---|
| Initiator | B | C |
| Run Time (h) | 42 | 67* |

*Run manually stopped. No significant polymer build-up.

It was also found that use of Initiator C (i.e. V601) improved the properties of the foam produced from the PMPO. The basic foam formulation is set forth below in Table 7. The specific PMPO is identified in Table 8 for each of Examples 12-14. Examples 12-14 (see Table 8) illustrate the improvement in foam properties compared to the control PMPO (i.e. Example 7 in Table 5), which used Initiator B (i.e. Vazo 64).

TABLE 7
Foam Formulation

| Component | PPHP |
|---|---|
| PMPO | 55 |
| Polyol F | 45 |
| Water (distilled) | 3.02 |
| DEOA-LF | 1.38 |
| DC 5043 | 1.0 |
| DABCO 33LV | 0.35 |
| NIAX A-1 | 0.08 |
| TDI | 38.33 |
| Index | 100 |

TABLE 8
Foam Property Results

| | Example 12 | Example 13 | Example 14 |
|---|---|---|---|
| PMPO | Ex. 7 | Ex 8 | Ex 9 |
| Density, ft/lb3 | 2.2 | 2.2 | 2.2 |
| IFD 25%, lb | 33.9 | 35.2 | 37.6 |
| IFD 65%, lb | 100.4 | 105.7 | 111.4 |
| Tensile, psi | 18.5 | 19.7 | 20.2 |
| Elongation, % | 100.3 | 104.5 | 104.0 |
| Tear, psi | 1.33 | 1.62 | 1.59 |
| Compression Set, % | 31.2 | 30.6 | 27.5 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A polymer polyol comprising the reaction product of:
(1) a base polyol,
(2) a preformed stabilizer,
and
(3) at least one ethylenically unsaturated monomer,
in the presence of
(4) at least one free-radical polymerization initiator comprising an azo compound that is free of nitrile groups,
and, optionally,
(5) a polymer control agent.

2. The polymer polyol of claim 1, wherein (4) said azo compound that is free of nitrile groups is an azocarboxylic acid ester corresponding to the formula: 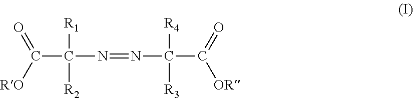
wherein:
R₁, R₂, R₃ and R₄ may be identical or different and each is independently selected from the group consisting of (i) linear or branched alkyls containing from 1 to 9 carbon atoms, optionally substituted with one or more substituents selected from hydroxyl, C₁ to C₆ alkoxy and halogen substituents; (ii) C₃ to C₁₂ cycloalkyls, optionally substituted with one or more substituents selected from C₁ to C₆ alkyl, C₁ to C₆ alkoxy, hydroxyl and halo groups; (iii) aralkyls optionally substituted with one or more C₁ to C₆ alkyl, C₁ to C₆ alkoxy, hydroxyl and halo groups; and (iv) aryls optionally substituted with one or more substituents selected from C₁ to C₆ alkoxy, hydroxyl and halo groups; in which at least one of the combinations R₁-R₂ and R₃-R₄ may form an aliphatic ring;
and
R′ and R″ may be identical or different and are independently selected from the group consisting of hydrogen and linear or branched C₁ to C₁₀ aliphatic radicals.

3. The polymer polyol of claim 1, wherein (4) said azo compound that is free of nitrile groups is selected from the group consisting of (a) dimethyl-2,2′-azobisisobutyrate, (b) diethyl-2,2′-azobisisobutyrate and (c) mixtures thereof.

4. The polymer polyol of claim 1, wherein the solids content ranges from about 20% to about 65% by weight, based on the total weight of the polymer polyol.

5. The polymer polyol of claim 1, wherein said free-radical polymerization initiator is present in an amount of from about 0.01% to about 2% by weight, based on 100% by weight of the total feed.

6. The polymer polyol of claim 1, wherein (1) said base polyol has a functionality of at least about 2 to less than or equal to about 10, and an OH number of at least about 10 to less than or equal to about 1900; and (3) said ethylenically unsaturated monomer is selected from the group consisting of styrene, acrylonitrile and mixtures thereof.

7. The polymer polyol of claim 6, wherein (3) said ethylenically unsaturated monomer comprises a mixture of styrene and acrylonitrile in a weight ratio of 80:20 to 20:80 (styrene to acrylonitrile).

8. A continuous process for preparing a polymer polyol comprising:
(A) free-radically polymerizing:
(1) a base polyol,
(2) a preformed stabilizer,
and
(3) at least one ethylenically unsaturated monomer,
in the presence of
(4) at least one free-radical polymerization initiator comprising an azo compound that is free of nitrile groups,
and, optionally,
(5) a polymer control agent.

9. The process of claim 8, wherein (4) said azo compound that is free of nitrile groups is an azocarboxylic acid ester corresponding to the formula: 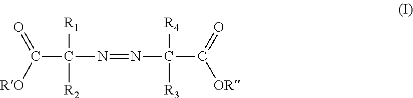
wherein:
R₁, R₂, R₃ and R₄ may be identical or different and each is independently selected from the group consisting of (i) linear or branched alkyls containing from 1 to 9 carbon atoms, optionally substituted with one or more substituents selected from hydroxyl, C₁ to C₆ alkoxy and halogen substituents; (ii) C₃ to C₁₂ cycloalkyls, optionally substituted with one or more substituents selected from C₁ to C₆ alkyl, C₁ to C₆ alkoxy, hydroxyl and halo groups; (iii) aralkyls optionally substituted with one or more C₁ to C₆ alkyl, C₁ to C₆ alkoxy, hydroxyl and halo groups; and (iv) aryls optionally substituted with one or more substituents selected from C₁ to C₆ alkoxy, hydroxyl and halo groups; in which at least one of the combinations R₁-R₂ and R₃-R₄ may form an aliphatic ring;
and
R′ and R″ may be identical or different and are independently selected from the group consisting of hydrogen and linear or branched C₁ to C₁₀aliphatic radicals.

10. The process of claim 8, wherein (4) said azo compound that is free of nitrile groups is selected from the group consisting of (a) dimethyl-2,2′-azobisisobutyrate, (b) diethyl-2,2′-azobisisobutyrate and (c) mixtures thereof.

11. The process of claim 8, wherein the solids content ranges from about 20% to about 65% by weight, based on the total weight of the polymer polyol.

12. The process of claim 8, wherein said free-radical polymerization initiator is present in an amount of from about 0.01% to about 2% by weight, based on 100% by weight of the total feed.

13. The process of claim 8, wherein (1) said base polyol has a functionality of at least about 2 to less than or equal to about 10, and an OH number of at least about 10 to less than or equal to about 1900; and (3) said ethylenically unsaturated monomer is selected from the group consisting of styrene, acrylonitrile and mixtures thereof.

14. The process of claim 13, wherein (3) said ethylenically unsaturated monomer comprises a mixture of styrene and acrylonitrile in a weight ratio of 80:20 to 20:80 (styrene to acrylonitrile).
